(19) United States
(12) Patent Application Publication
(10) Pub. No.: US 2005/0283733 A1
(43) Pub. Date: Dec. 22, 2005

(54) Method and circuit configuration for computer-assisted generation of a graphical user interface

(75) Inventors: Michael Ellinger, Matzen (AT); Hans Haugeneder, Geratskirchen (DE); Joachim Ritter, Koln (DE); Sebastian Witte, Hannover (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 11/098,360

(22) Filed: Apr. 4, 2005

Related U.S. Application Data
(63) Continuation of application No. PCT/EP03/10980, filed on Oct. 2, 2003.

(30) Foreign Application Priority Data
Oct. 2, 2002 (DE) 102 46 112.0

(51) Int. Cl. G06F 17/00

(52) U.S. Cl. 715/762

(57) ABSTRACT

For computer-assisted generation of a graphical user interface for an equipment monitoring unit and/or equipment control unit of at least one appliance such as a household appliance, a base structure of the graphical user interface is determined from a base configuration file. Equipment-specific static detail data from an equipment-specific equipment configuration file and equipment-specific dynamic detail data, which are provided by the device to be controlled and which describe a state of the device to be monitored and/or to be controlled, are inserted into the base structure as defined by information stored in at least one configuration file on the sites in the graphical user interface at which what equipment-specific static or dynamic data are to be stored.

### CROSS-REFERENCE TO RELATED APPLICATION

This is a continuing application, under 35 U.S.C. § 120, of copending international application No. PCT/EP2003/010980, filed Oct. 2, 2003, which designated the United States; this application also claims the priority, under 35 U.S.C. § 119, of German patent application No. 102 46 112.0, filed Oct. 2, 2002; the prior applications are herewith incorporated by reference in their entirety.

### BACKGROUND OF THE INVENTION

### FIELD OF THE INVENTION

The present invention relates to a method for computer-assisted generation of a graphical user interface for an equipment-monitoring unit and/or equipment control unit of at least one appliance, such as a household appliance. A base structure of the graphical user interface is determined from a base configuration file, wherein, depending on the base structure of the graphical user interface, equipment-specific static detail data are determined from an equipment-specific equipment configuration file. Depending on the base structure of the graphical user interface, equipment-specific dynamic detail data are determined, which are provided by the device to be controlled and which describe a state of the device to be monitored and/or to be controlled, and wherein the graphical user interface is formed according to the base structure and the static detail data and the dynamic detail data are inserted into the graphical user interface.

### SUMMARY OF THE INVENTION

It is accordingly an object of the invention to provide a method and a circuit configuration for computer-assisted generation of a graphical user interface which overcome the above-mentioned disadvantages of the prior art methods and devices of this general type. It is thus the object of the present invention to provide a method that is able to insert equipment-specific static and dynamic data at any positions in the respective graphical user interface which may be specified and which may be varied, in an especially simple fashion without it being necessary to completely re-configure for this purpose the entire process sequence and therefore the entire programming forming the basis of this process sequence.

With the foregoing and other objects in view there is provided, in accordance with the invention, a method for computer-assisted generation of a graphical user interface for an equipment monitoring unit and/or equipment control unit of at least one appliance such as household appliances. The method includes determining a base structure of the graphical user interface from a base configuration file storing base structure data, determining equipment-specific static detail data from an equipment-specific equipment configuration file in dependence on the base structure of the graphical user interface, and determining equipment-specific dynamic detail data in dependence on the base structure of the graphical user interface. The equipment-specific dynamic detail data is provided by the appliance to be controlled and describes a state of the appliance to be monitored and/or to be controlled. Information is stored in at least one configuration file on sites in the graphical user interface at which the equipment-specific static detail data and the equipment-specific dynamic detail data are to be stored. The graphical user interface is formed according to the base structure and the equipment-specific static detail data and the equipment-specific dynamic detail data inserted into the graphical user interface. The equipment-specific static detail data and the equipment-specific dynamic detail data are inserted into the graphical user interface on a basis of the information in the configuration file.

The object indicated hereinbefore is solved according to the invention in a method of the type specified initially by additionally storing in at least one configuration file information on the sites in the graphical user interface at which equipment-specific static or dynamic data is to be stored, and inserting the equipment-specific static and dynamic data into the graphical user interface on the basis of the information.

The invention brings with it the advantage that which equipment-specific static or dynamic detail data is to be stored and therefore inserted at which sites in the graphical user interface is only specified by the information contained in the configuration file provided in each case. Thus, if the positions and/or the contents of certain display fields or regions of the respective graphical user interface are to be changed, this merely needs to be taken into account by corresponding modified entries in the existing configuration file which is possible by relatively simple process steps. A comprehensive modification of the entire process sequences and the entire programming forming the basis thereof is not required by the present invention. The invention is also distinguished by a high degree of flexibility with regard to specifying and modifying display fields and regions in the respective graphical user interface and the equipment-specific static and dynamic detail data to be inserted therein.

More appropriately, the data specifying the respective graphical user interface are provided as WML (Wireless Markup Language) or as HTML data (Hypertext Markup Language) which are subjected to XMLC compiling (Extended Markup Language Compiling) as a result of which a Document Object Model (DOM) representation of the relevant graphical user interface is obtained. This yields the advantage that it is possible to work relatively simply with an object-oriented representation of the respective graphical user interface which contains an especially simple procedure.

The configuration file is preferably provided by a spreadsheet file (EXCEL) whose data representing the information is converted into XML (Extended Markup Language) data. This yields the advantage that the configuration file can be created particularly simply and that the data information contained therein can be received or modified particularly simply.

According to an especially appropriate further development of the method according to the invention, the individual elements of the base structure data to be used for the different graphical user interfaces are stored in separate base configuration files which are selected according to the respectively desired graphical user interface and are used to prepare the relevant graphical user interface. This measure brings with it the advantage that in an especially simple fashion surface elements required or used for different user interfaces only need to be stored once in each case in order nevertheless to be able to be used in a plurality of different user interfaces. The overall expenditure required to compile different graphical user interfaces is thus significantly reduced compared with the case where the base structure data required for each graphical user interface are stored completely in a separate base configuration file.

The information on the sites at which equipment-specific static or dynamic data are to be entered into the total number of possible graphical user interfaces, is preferably stored in individual configuration files, which are selected according to the respectively desired graphical user interface and on which basis the respective static and dynamic data which are likewise stored in individual files are inserted into the graphical user interface desired in each case are inserted. By this measure, information on equipment-specific static or dynamic detail data to be entered at the same sites in a plurality of graphical user interfaces and also the relevant static and dynamic detail data itself can advantageously be made available, e.g. stored, in an especially simple fashion. Multiple storage of the relevant information, for example, according to the graphical user interfaces possible in each case is thus not necessary.

More appropriately, all the files are stored in at least one memory of a building gateway computer device, as a result of whose operation the respective graphical user interface is provided and the respective equipment-specific static and dynamic data are inserted. This yields the advantage of an especially simple sequence of the method according to the invention in one system in which a plurality of appliances, especially household appliances are interconnected via a highway configuration to a building gateway or a building transition device.

Preferably used for executing the method according to the invention is a circuit configuration in an equipment monitoring/control unit of at least one appliance, especially a household appliance. The circuit configuration contains a processor unit with the aid of which the respective graphical user interface is to be created and with which at least one memory which stores the data used to create the respective graphical user interface and the equipment-specific static and dynamic data to be inserted in each case into the relevant graphical user interface, is connected.

The circuit configuration according to the invention is characterized in that information on the sites of the respective graphical user interface at which what data of the respective equipment-specific static and dynamic detail data are to be stored, are stored in at least one separate memory or memory region which is connected to the processor unit and that, as defined by this information, the equipment-specific static and dynamic detail data to be inserted in the graphical user interface to be provided in each case, can be selectively retrieved.

The advantage is hereby achieved that the method according to the invention with its particular advantages can be executed or implemented with particularly low expenditure on circuitry.

The method specified hereinbefore and an equipment monitoring and/or equipment control unit operated according to this method are to some degree generically taught in German Patent Application 102 08 146.8 which is commonly assigned and is hereby incorporated by reference in its entirety into the instant application. Although a graphical user interface for monitoring and/or controlling various equipment can be provided very simply by the relevant method for a plurality of different equipment, in practice however it has been found to be desirable to have more flexibility with regard to the insertion of the static and dynamic detail data into the respective graphical user interface so that such static and dynamic detail data can be inserted simply at modified positions in the respective graphical user interface.

Other features which are considered as characteristic for the invention are set forth in the appended claims.

Although the invention is illustrated and described herein as embodied in a method and a circuit configuration for computer-assisted generation of a graphical user interface, it is nevertheless not intended to be limited-to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a first exemplary embodiment of the invention; and

FIG. 2 is a block diagram of a second exemplary embodiment of the invention.

### DESCRIPTION OF THE PREFERRED EMBODIMENTS

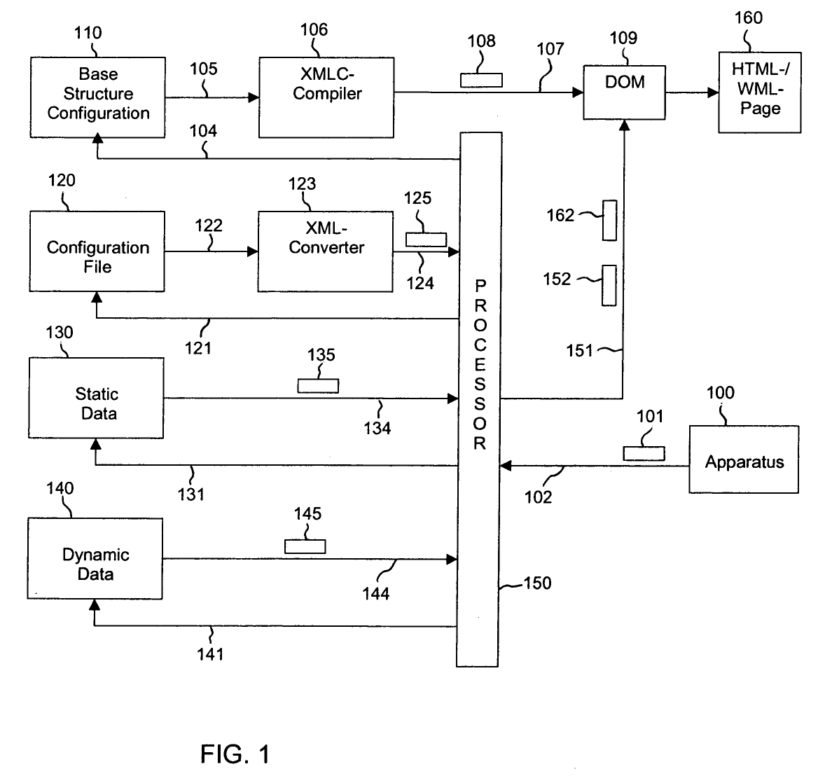

Referring now to the figures of the drawing in detail and first, particularly, to FIG. 1 thereof, there is shown a block diagram of a circuit configuration used for implementing a method according to a first exemplary embodiment of the invention for computer-assisted generation of a graphical user interface of an equipment monitoring unit and/or equipment control unit of an appliance, especially a household appliance. It may be noted at this point that the relevant equipment monitoring unit or equipment control unit and its connection to the device to be monitored or to be controlled in each case is merely indicated by a device designated as 100. In this context, it is assumed here that the same relationships exist in this connection as are specified in commonly assigned German Patent Application 102 08 146.8 which is hereby incorporated by reference herein in its entirety.

In addition, it is assumed in connection with FIG. 1 that when the afore-mentioned equipment monitoring unit and/or equipment control unit, i.e. the device 100 shown in FIG. 1, is switched on, a base structure request message 101 is delivered via a request line 102 to a computer device which is formed by a processor 150 which receives the relevant message 101. The processor 150, via a control line 104, controls a base structure configuration file 110 that is also to be designated as a template file. The processor 150 is configured here such that it can process markup language (ML) data. Stored in the aforesaid base structure configuration file 110 are user interfaces corresponding to base structures which are associated with the appliances to be monitored or to be controlled in each case, and in the present case in WML format or in HTML format. The relevant base structures specify the layout of the respective graphical user interface. At the sites or regions at which equipment-specific static or dynamic detail data are to be entered, individual substitute symbols are to be entered to which reference will be made subsequently. The base structure request message 101 thus requests the relevant equipment-monitoring unit or equipment control unit to transmit a certain base structure of a graphical user interface to be compiled.

In the present case, the base structure selected from the base structure or, for short, base configuration file 110 undergoes compiling in an XMLC compiler 106 (Extended Markup Language Compiling) via a connecting line 105. The data 108 thus obtained are made available via a connecting line 107 in the form of base structure data in a Document Object Model (DOM) or in a device 109 containing the object model. Now, equipment-specific static and dynamic detail data are to be inserted at specified sites or regions into the respective base structure, which is present in the document object model in object-oriented representation, of a graphical screen interface still to be completed and therefore to be compiled.

According to FIG. 1, an equipment configuration file 130 is provided for the provision of equipment-specific static detail data, which can be correspondingly controlled via a control line 131 from the processor 150 and which, when controlled, delivers the static detail data 135 specified to the processor 150 via a data line 134.

A dynamic data file 140 which provides equipment-specific dynamic detail data, designated for short as dynamic data, is used to provide the required dynamic detail data according to FIG. 1, which data file is caused by the processor 150 via a control line 141 to deliver dynamic detail data 145 specified via a connection line 144. The relevant dynamic detail data themselves are provided by the device to be controlled in each case, such as the device 100. The dynamic detail data describe a state of the relevant device, such as, for example, a temperature of a certain process.

In this way, equipment-specific static and dynamic detail data that are to be inserted into the base structure data available in the document object model 109, are made available to the processor 150.

It is now explained how, according to the invention, which equipment-specific static or dynamic detail data are to be inserted at which sites of the respective base structure and therefore in the respective graphical user interface.

According to FIG. 1, a configuration file 120 that is also to be designated as a meta-configuration file, is provided. The configuration file 120 can be controlled by the processor 150 via a control line 121. In the configuration file 120 it is now specified for the individual fields and regions in the respective base structure of the graphical user interface which equipment-specific static or dynamic detail data are to be entered. The individual sites or regions of the base structure of the respective graphical user interface can in this case, for example be specified by unique ID information (identification information) such as are used in the relevant base structure, for example, as substitute symbols or they can refer to these substitute symbols. Addresses relating to these detail data in the afore-mentioned files 130 and 140, for example, can be used to specify the equipment-specific static or dynamic detail data to be taken into account in each case.

Thus, when controlled, the configuration file 120 on the one hand specifies at which sites in the base structure of the respective graphical user interface, present in the document object model 109, equipment-specific static or dynamic detail data are to be inserted and on the other hand, when controlled, the file specifies which data of the equipment-specific static or dynamic detail data made available by the files 130 and 140 are to be inserted into the relevant base structure.

The configuration file 120 is preferably present as a spreadsheet file, for example as an EXCEL file. According to FIG. 1, the content of the file is passed via an output line 122 to an XML converter that converts the relevant data of the file into XML format (Extended Markup Language) and makes the data 125 thus converted available to the processor 150 via an output line 124. Using this information or data 125 made available to the processor 150 from the configuration file 120, the processor retrieves the equipment-specific static or dynamic detail data required in each case by correspondingly controlling the static file 130 via the control line 131 and the dynamic file 140 via the control line 141. The required equipment-specific static detail data 135 are then transmitted from the static file 130 via the connecting line 134 to the processor 150 and the required equipment-specific graphic detail data 145 are then transmitted from the dynamic file 140 via the connecting line 144 to the processor 150. The processor 150 then transmits the data 152 or 162 corresponding to the relevant detail data 135 and 145 via an output line 151 to the base structure of the desired graphical user interface to be created in the document object model 109 and inserts the relevant detail data 152, 162 into the sites or regions known to it from the information 125 which originates from the configuration file 120.

After the detail data 152 and 162 has been inserted into the mentioned base structure of the graphical user interface, the HTML or WML page 160 of the relevant user interface indicated in FIG. 1 is thus created and can now be used. Meanwhile, the monitoring and/or control processes associated therewith are not discussed in further detail here since these are specified in detail in commonly assigned German Patent Application 102 08 146.8. However, it may be mentioned at this point that all files mentioned in connection with FIG. 1 can be stored in at least one memory which in the case of appliances to be monitored and/or to be controlled, especially household appliances, belongs to a building gateway or building-transition device computer device for which the processor 150 shown in FIG. 1 can be used, as a result of whose operation the respective graphical user interface is provided and the respective equipment-specific static and dynamic detail data are inserted into the interface.

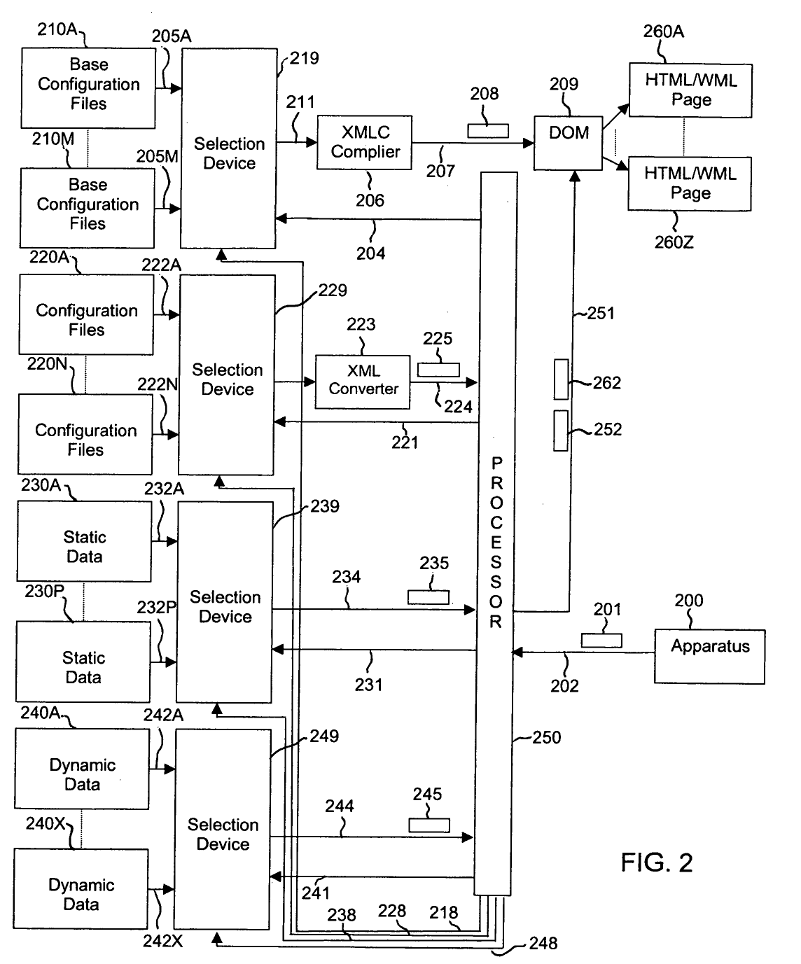

FIG. 2 shows a second exemplary embodiment or a modification of the configuration shown in FIG. 1 and the method according to the present invention associated therewith.

The exemplary embodiment of the invention shown in FIG. 2 substantially differs from the embodiment shown in FIG. 1 in that the files designated in FIG. 1 as 110, 120, 130 and 140 are in each case provided in a plurality in FIG. 2 and are in each case controllable via a relevant selection device both on the input side and on the output side. For the designation of the elements in FIG. 2 corresponding to the elements shown in FIG. 1, corresponding reference numbers each beginning with 2 are used.

Thus, the base configuration file designated as 110 in FIG. 1 is formed according to FIG. 2 by base configuration files 210A to 210M (in each case, designated as base configuration file) (with A to M≧2) in which the individual elements of the base structure data to be used for different graphical user interfaces are stored. The relevant base configuration files 210A to 210M are connected via bi-directionally operable connecting lines 205A to 205M to a selection device 219 that is connected via a control line 204 on the input side to a processor 250 that corresponds to the processor 150 according to FIG. 1. On the output side the connection device 219 is connected via a connecting line 211 to an XMLC compiler or compiler 206 which corresponds to the computer 106 according to FIG. 1. The compiler 206 is connected via a connecting line 207 on the output side to a device 209 containing a document object model to which the base structure data 208 required for the graphical user interface to be created in each case is supplied via the relevant connecting line 207. The selection device 219 is furthermore connected to the processor 250 via a selection control line 218.

The configuration files 220A to 220N (where A to N≧2) corresponding to the configuration file 120 according to FIG. 1 are connected via bi-directionally operable lines 222A to 222N to a selection device 229 which is connected on the input side via a connecting line 221 to the processor 250 and which is connected on the output side to the processor 250 via a conversion device 223 corresponding to the XML conversion device 123 according to FIG. 1, which is connected on the output side to the processor 250 via a connecting line 224 and transfers via the line data or information 225 corresponding to the information 125 according to FIG. 1. In addition, the selection device 229 is connected to the processor 250 via a selection control line 228.

In FIG. 2 the static files 230A to 230P (where A to P≧2), which are connected to a selection device 239 via bi-directionally operable connecting lines 232A to 232P, correspond to the static file 130 shown in FIG. 1. The selection device 239 is connected on the input side via a control line 231 and on the output side via a control line 235 to the processor 250. Equipment-specific static detail data 235 corresponding to the detail data 135 according to FIG. 1 can be transmitted via the output line 234. In addition, the selection device 239 can be connected to the processor 250 via a selection control line 238.

The dynamic files 240A to 240X (where A to X≧2), which are connected to a selection device 259 via bi-directionally operable connecting lines 242A to 242X, correspond to the dynamic file 140 according to FIG. 1. The selection device 249 is connected on the input side via a control line 241 and on the output side via an output line 245 to the processor 250. Dynamic detail data 245 corresponding to the equipment-specific dynamic detail data 145 mentioned in connection with FIG. 1 can be transferred via this output line 244. The selection device 249 is furthermore connected to the processor 250 via a selection control line 248.

The processor 250 corresponding to the processor 150 according to FIG. 1 is connected on the input side via a connecting line 202 to a device 200 from which data 201 corresponding to the data 101 according to FIG. 1 can be transferred via the relevant connecting line 202.

On the output side the processor 250 according to FIG. 2 corresponding to the processor 150 according to FIG. 1 is connected via a connecting line 251 to the device that has the document object model 209 containing the base structure for the respective graphical user interface to be provided. Detail data 252 and 262 for insertion into the base structure provided there of the graphical user interface to be created are to be transmitted via the connecting line 251 to the relevant document object model.

Since it must have become clear from the preceding description of the relationships shown in FIG. 2 that the substantial differences compared with the relationships shown in FIG. 1 are the fact that the files 110, 120, 130 and 140 shown in each case as single files in FIG. 1 are in each case formed by a plurality of files according to FIG. 2, which can each be controlled via their own selection device, the principle of the method to be used in the circuit configuration according to FIG. 2 is explained in the required scope.

As mentioned above, according to FIG. 2, the individual elements for the base structure data to be used for the various graphical user interfaces are stored in the separate base configuration files 210A to 210M that are selected according to the graphical user interface desired in each case and are used to provide the relevant graphical user interface. Thus, individual elements of base structures which are used repeatedly in different graphical user interfaces only need to be stored once and can nevertheless be used for a plurality of graphical user interfaces. In this way, it is possible to flexibly compile the base structure of a wide range of different graphical user interfaces in a simple fashion.

As a result of the division of the configuration file 120 according to FIG. 1 into a plurality of configuration files 220A to 220N according to FIG. 2, it is furthermore possible to divide the information stored in these files which makes efficient control possible, for example, with regard to the information on the sites in the respective base structure at which equipment-specific static detail data are to be inserted and with regard to the information on the sites in the respective base structure at which equipment-specific static detail data are to be stored. In this case, the information that is always to be inserted at the same site or in the same region of the various base structures of graphical user interfaces can all be stored in a single configuration file. Control advantages can also be achieved hereby.

In the static and dynamic files 230A to 230P or 240A to 240X according to FIG. 2, static or dynamic detail data can be contained in a wide range of orders or series, for example, in the order of their importance for the processes to be monitored and/or to be controlled in each case. Flexibility or facilitation with regard to control can also be achieved hereby compared to the relationships that have been described in connection with FIG. 1.

In view of the relationships explained hereinbefore with reference to FIG. 2 it is therefore possible to compile relatively simply, in a flexible fashion, various graphical user interfaces which can be provided by the device 209 containing the document object model according to FIG. 2 as different HTML or WML pages 260A to 260Z (where A to Z≧2).

The files 210A to 210M, 220A to 220N, 230A to 230P and 240A to 240X shown in FIG. 2 can also be stored, like the corresponding files in FIG. 1, in at least one memory of a building gateway computer device, which for example comprises the processor 250.

1. A method for computer-assisted generation of a graphical user interface for an equipment monitoring unit and/or equipment control unit of at least one appliance such as household appliances, which comprises the steps of:
determining a base structure of the graphical user interface from a base configuration file storing base structure data;
determining equipment-specific static detail data from an equipment-specific equipment configuration file in dependence on the base structure of the graphical user interface;
determining equipment-specific dynamic detail data in dependence on the base structure of the graphical user interface, the equipment-specific dynamic detail data being provided by the appliance to be controlled and describes a state of the appliance to be monitored and/or to be controlled;
storing in at least one configuration file information on sites in the graphical user interface at which the equipment-specific static detail data and the equipment-specific dynamic detail data are to be stored;
forming the graphical user interface according to the base structure and the equipment-specific static detail data and the equipment-specific dynamic detail data inserted into the graphical user interface; and
inserting the equipment-specific static detail data and the equipment-specific dynamic detail data into the graphical user interface on a basis of the information in the configuration file.

2. The method according to claim 1, which further comprises:
providing all of the data specifying the graphical user interface as WML or as HTML data; and
subjecting the data specifying the graphical user interface to XMLC compiling as a result of which a document object model representation of the graphical user interface is obtained.

3. The method according to claim 1, which further comprises providing the configuration file as a spreadsheet file whose data representing the information is converted into XML data.

4. The method according to claim 1, which further comprises storing individual elements of the base structure data to be used for different graphical user interfaces in separate base configuration files which are selected according to a respectively desired graphical user interface and are used to prepare the respective graphical user interface.

5. The method according to claim 4, which further comprises storing the information on the sites at which the equipment-specific static detail data and the equipment-specific dynamic detail data are to be entered into all of the total possible number of graphical user interfaces, in individual configuration files, which are selected according to the respectively desired graphical user interface and on which basis the respective equipment-specific static detail data and the respective equipment-specific dynamic data which are likewise stored in individual files are inserted into the respective graphical user interface desired in each case.

6. The method according to claim 1, which further comprises storing all of the files in at least one memory of a building gateway computer device as a result of whose operation the graphical user interface is provided and the equipment-specific static detail data and the equipment-specific dynamic data are inserted.

7. A circuit configuration for an equipment monitoring/control unit of at least one appliance, comprising:
a processor unit for assisting in creating a respective graphical user interface, said processor unit programmed to:
determine a base structure of the respective graphical user interface from a base configuration file storing base structure data;
determine equipment-specific static detail data from an equipment-specific equipment configuration file in dependence on the base structure of the respective graphical user interface;
determine equipment-specific dynamic detail data in dependence on the base structure of the respective graphical user interface, the equipment-specific dynamic detail data being provided by the appliance to be controlled and describes a state of the appliance;
store in at least one configuration file information on sites in the respective graphical user interface at which the equipment-specific static detail data and the equipment-specific dynamic detail data are to be stored;
form the respective graphical user interface according to the base structure, the equipment-specific static detail data and the equipment-specific dynamic detail data inserted into the respective graphical user interface; and
insert the equipment-specific static detail data and the equipment-specific dynamic detail data into the respective graphical user interface on a basis of the information in the configuration file;
at least one first memory connected to said processor unit and storing the data used to create the respective graphical user interface, the equipment-specific static detail data and the equipment-specific dynamic detail data to be inserted in each case into the respective graphical user interface; and
at least second separate memory storing the information on the sites of the respective graphical user interface at which what data of the equipment-specific static detail data and the equipment-specific dynamic detail data are to be stored, said second separate memory connected to said processor unit and that, as defined by the information, the equipment-specific static detail data and the equipment-specific dynamic detail data to be inserted in the graphical user interface, can be selectively retrieved.
